(19) United States
(12) Patent Application Publication
(10) Pub. No.: US 2013/0215924 A1
(43) Pub. Date: Aug. 22, 2013

(54) NON-HERMETIC, MULTI-EMITTER LASER PUMP PACKAGES AND METHODS FOR FORMING THE SAME

(71) Applicants: John McKenna Brennan, Klongtoey Nua (TH); Wanchai Chinpongpan, Bangjak Prakanong (TH); Woraphat Dockchoorung, Nonthaburi (TH); Sanyapong Puthgul, Lumlukka (TH); Amorn Runarom, Samutsakhon (TH)

(72) Inventors: John McKenna Brennan, Klongtoey Nua (TH); Wanchai Chinpongpan, Bangjak Prakanong (TH); Woraphat Dockchoorung, Nonthaburi (TH); Sanyapong Puthgul, Lumlukka (TH); Amorn Runarom, Samutsakhon (TH)

(21) Appl. No.: 13/765,803

(22) Filed: Feb. 13, 2013

Related U.S. Application Data
(60) Provisional application No. 61/599,613, filed on Feb. 16, 2012.

(51) Int. Cl. H01S 3/091

(52) U.S. Cl. CPC H01S 3/091
USPC 372/70; 228/175

(57) ABSTRACT

According to one embodiment described herein, a method for assembling a multi-emitter laser pump package, includes providing a base substrate comprising a laser riser block. A chip-on-hybrid laser assembly is bonded to the laser riser block with a solder preform. A scalar module is bonded to the base substrate with an adhesive such that an output of the chip-on-hybrid laser assembly is optically coupled into an input of the scalar module. A sidewall ring is adhesively bonded to the base substrate with a non-hermetic adhesive, the sidewall ring comprising a fiber interconnect fitting and at least one electrical connector. A first end of a fiber interconnect is optically coupled to an output of the scalar module and a second end of the fiber interconnect is positioned in the fiber interconnect fitting of the sidewall ring.

### CROSS-REFERENCE TO RELATED APPLICATIONS

This application claims the benefit of priority under 35 U.S.C. §119 of U.S. Provisional Application Ser. No. 61/599,613 filed on Feb. 16, 2012 the content of which is relied upon and incorporated herein by reference in its entirety.

### BACKGROUND

1. Field

The present specification generally relates to multi-emitter laser pump packages and, more specifically, to non-hermetic, multi-emitter laser pump packages and methods for forming the same.

2. Technical Background

Multi-emitter laser pump packages are used in a variety of commercial applications. For example, multi-emitter laser pump packages may be utilized for signaling in telecommunications applications. Alternatively, multi-emitter laser pump packages may be used for cutting and joining metals in industrial manufacturing applications.

Conventional multi-emitter laser pump packages are generally hermetically sealed to prevent degradation of the components, particularly when the packages are employed in applications where replacement of the package may be difficult or impossible. Hermetically sealing these multi-emitter laser pump package requires the use of more expensive materials thereby increasing the overall cost of the package. Moreover, hermetically sealing these packages often requires additional processing steps even further increasing the cost of the package. Perhaps most importantly, several of the steps required to hermetically seal the package require elevated temperatures which can result in the misalignment of optical components within the package, thereby destroying the utility of the package and further increasing production costs.

Accordingly, a need exists for alternative multi-emitter laser pump packages which are non-hermetically sealed and methods for forming the same.

### SUMMARY

According to one embodiment, a method for assembling a multi-emitter laser pump package includes providing a base substrate comprising a laser riser block. A chip-on-hybrid laser assembly is bonded to the laser riser block with a solder preform. A scalar module is bonded to the base substrate with an adhesive such that an optical output of the chip-on-hybrid laser assembly is optically coupled into an input of the scalar module. A sidewall ring is adhesively bonded to the base substrate with a non-hermetic adhesive, the sidewall ring comprising a fiber interconnect fitting and at least one electrical connector. A first end of a fiber interconnect is optically coupled to an output of the scalar module and a second end of the fiber interconnect is positioned in the fiber interconnect fitting of the sidewall ring.

In another embodiment, a method for assembling a multi-emitter laser pump package includes providing a base substrate formed from oxygen-free high conductivity copper and comprising a laser riser block, a fiber interconnect riser block, and an optics riser block positioned between the laser riser block and the fiber interconnect riser block, wherein the laser riser block is proximate a rear end of the base substrate and the fiber interconnect riser block is proximate a front end of the base substrate. A chip-on-hybrid laser assembly is bonded to the laser module riser block with a solder preform. A scalar module is bonded to the base substrate with an adhesive. Collimating optics are positioned on the laser riser block and the optics riser block such that an optical output of the chip-on-hybrid laser assembly is directed through the collimating optics and into an input of the scalar module and an optical output of the scalar module is maximized. The collimating optics are then bonded to the laser riser block and the optics riser block with adhesive. A focusing lens is bonded to the scalar module riser block with an adhesive. A sidewall ring is adhesively bonded to the base substrate, the sidewall ring comprising a fiber interconnect fitting and at least one electrical connector. The at least one electrical connector of the sidewall ring is electrically coupled to the chip-on-hybrid laser assembly. An optical fiber interconnect is optically aligned with the focusing lens and positioned in the fiber interconnect fitting. The optical fiber interconnect is bonded to the fiber interconnect riser block with adhesive.

In yet another embodiment, a multi-emitter laser pump package includes a base substrate comprising a laser riser block with a sidewall ring adhesively bonded to the base substrate with a non-hermetic adhesive, the sidewall ring comprising a fiber interconnect fitting and at least one electrical connector. A chip-on-hybrid laser assembly is bonded to the laser riser block with a solder preform and electrically coupled to the at least one electrical connector of the sidewall ring. A scalar module is bonded to the base substrate with an adhesive and optically coupled to the chip-on-hybrid laser assembly such that an output of the chip-on-hybrid laser assembly is received by the scalar module, scaled and emitted from an output of the scalar module. The package also includes a fiber interconnect having a first end optically coupled to the output of the scalar module and a second end positioned in the fiber interconnect fitting.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operation of the claimed subject matter.

### BRIEF DESCRIPTION OF THE DRAWINGS

FIG. 1 schematically depicts a cut away cross section of a multi-emitter laser pump package according to one or more embodiments shown and described herein;

FIG. 2 schematically depicts an exploded view of a multi-emitter laser pump package according to one or more embodiments shown and described herein;

FIG. 3 schematically depicts a portion of a chip-on-hybrid laser assembly and a corresponding soldering pad of the multi-emitter laser pump package of FIG. 2;

FIG. 4 schematically depicts the collimating optics of the multi-emitter laser pump package of FIG. 2;

FIG. 5 schematically depicts a portion of a focusing lens of the multi-emitter laser pump package of FIG. 2;

FIG. 6 schematically depicts a base substrate of the multi-emitter laser pump package of FIG. 2;

FIG. 7 schematically depicts a sidewall ring of the multi-emitter laser pump package of FIG. 2; and

FIG. 8 schematically depicts an exploded view of a prior art multi-emitter laser pump.

### DETAILED DESCRIPTION

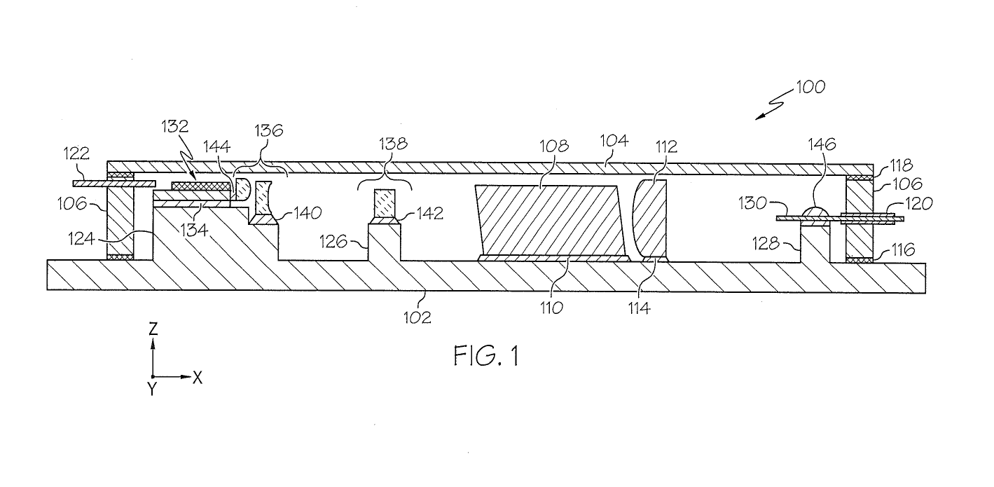

Reference will now be made in detail to embodiments of multi-emitter laser pump packages, examples of which are illustrated in the accompanying drawings. Whenever possible, the same reference numerals will be used throughout the drawings to refer to the same or like parts. One embodiment of a multi-emitter laser pump package is schematically depicted in FIG. 1. The multi-emitter laser pump package generally comprises a base substrate on which a separate sidewall ring is adhesively bonded. A chip-on-hybrid laser assembly is bonded to the base substrate and optically coupled to a scalar module which is also bonded to the base substrate. The optical output of the scalar module is optically coupled to a first end of a fiber interconnect which is positioned in a fiber interconnect fitting extending through the sidewall ring. A lid is bonded to the sidewall ring to enclose the multi-emitter laser pump package. The bond between the base substrate and the sidewall ring and the bond between the base substrate and the sidewall ring are non-hermetic. The multi-emitter laser pump package and methods of forming the multi-emitter laser pump package will be described in more detail herein with specific reference to the appended drawings.

Referring initially to FIG. 8, a conventional multi-emitter laser pump package 800 is schematically depicted. The package 800 generally comprises a “bathtub” assembly 802 which is formed from a base plate 804 to which a sidewall ring 806 is welded such that a hermetic seal is formed between the base plate 804 and the sidewall ring 806. Accordingly, the base plate 804 and the sidewall ring 806 must be constructed from similar materials to facilitate welding the sidewall ring 806 to the base plate 804 to form the hermetic seal. In conventional multi-emitter laser pump packages, the base plate 804 and the sidewall ring 806 are commonly formed from a copper-tungsten alloy which significantly increases the cost of materials.

Further, in these conventional packages, the optical components of the package 800 are first assembled on and adhesively bonded to a metal sled 808. The metal sled 808 is then inserted into the bathtub assembly 802 and soldered to the bathtub assembly with solder preform 810. However, the solder preform temperature is generally greater than the glass transition temperature of the adhesives used to bond the optical components to the metal sled 808 and, as such, as the metal sled 808 is soldered to the bathtub assembly 802, the adhesives soften causing the optical components to become misaligned. This misalignment destroys the utility of the package 800, causing production losses and generally increasing the overall cost of the package 800. The multi-emitter laser pump packages and method for assembling the same described herein eliminate these deficiencies in conventional multi-emitter laser pump packages.

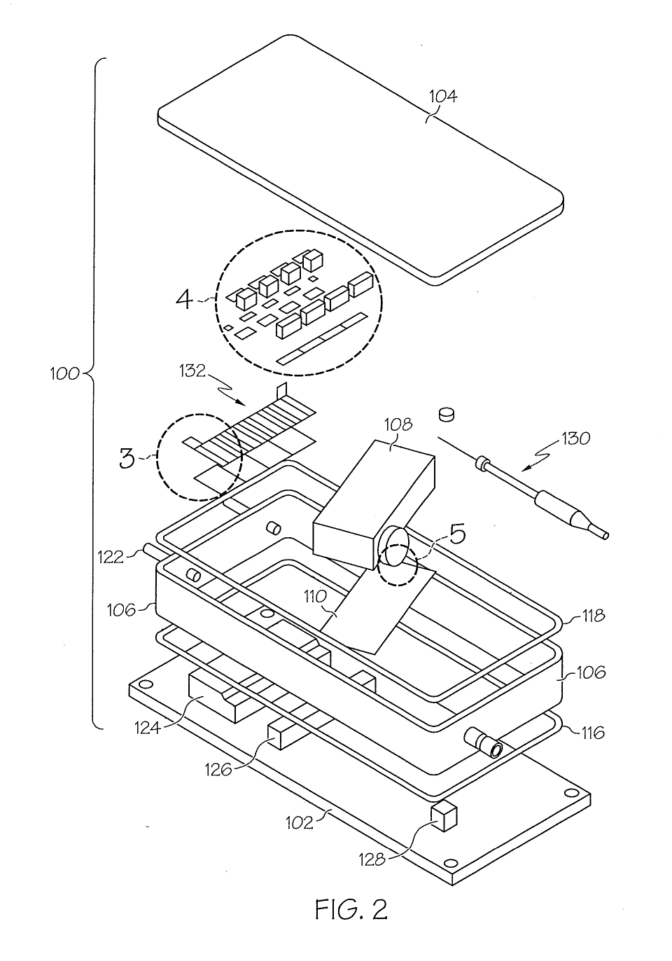

Referring now to FIGS. 1 and 2, a cut away cross section (FIG. 1) and an exploded view (FIG. 2) of a multi-emitter laser pump package 100 are schematically depicted. The multi-emitter laser pump package 100 generally includes a base substrate 102, a sidewall ring 106, and a lid 104 which, together, form the housing of the multi-emitter laser pump package 100. In addition, the multi-emitter laser pump package 100 also includes a plurality of optical components which are affixed to the base substrate 102 and non-hermetically sealed in the housing. The optical components may include a chip-on-hybrid laser assembly 132, a scalar module 108, a focusing lens 112 and a fiber interconnect 130. The optical components may also including collimating optics 136, 138 for coupling an optical output of the chip-on-hybrid laser assembly 132 into the scalar module 108.

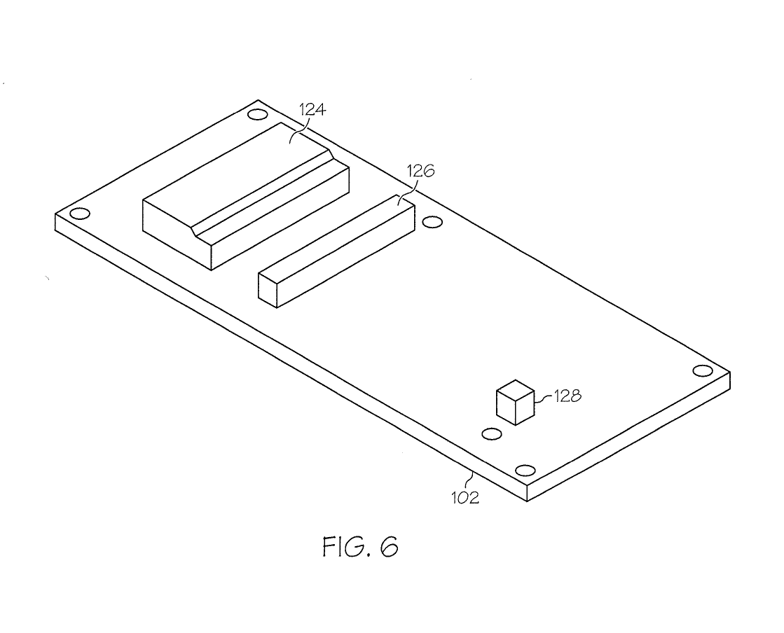

Referring now to FIGS. 1, 2 and 6, the base substrate 102 of the multi-emitter laser pump package 100 supports the various optical components of the multi-emitter laser pump package 100 and is generally formed from an electrically conductive material such as, for example, oxygen-free high conductivity copper (OFHC), or any other suitable electrically conductive material. In the embodiments described herein, the base substrate 102 is generally formed with a laser riser block 124, an optics riser block 126, and a fiber interconnect riser block 128. The fiber interconnect riser block 128 is positioned proximate a first end of the base substrate 102 and the laser riser block 124 is positioned proximate a second end of the base substrate 102. The optics riser block 126 is positioned between the fiber interconnect riser block 128 and the laser riser block 124 such that the optics riser block 126 is closer in proximity to the laser riser block 124 than the fiber interconnect riser block 128.

In the embodiments of the base substrate 102 depicted in FIGS. 1, 2 and 6, the base substrate 102 and riser blocks 124, 126, and 128 are integrally formed, such as when the base substrate 102 is formed by metal injection molding (MIM). However, in other embodiments (not shown) the base substrate 102 and riser blocks 124, 126, and 128 are formed as individual components and subsequently joined together, such as by soldering, brazing or the like. For example, the riser blocks 124, 126, and 128 may be individually formed and soldered to the base substrate 102 using an 80/20 AuSn eutectic solder for the block to base bond.

Referring now to FIGS. 1, 2 and 7, the sidewall ring 106 forms the sidewall of the housing of the multi-emitter laser pump package 100. The sidewall ring 106 may be formed from a variety of materials including, without limitation, ceramics such as alumina, silicon carbide and the like, metal such as copper alloys, aluminum alloys, and the like, or polymers, such as liquid crystal polymer. For example, in one embodiment, the sidewall ring 106 may be formed from a ceramic material such as alumina which is commonly used in electronic packaging. Alternatively, the sidewall ring may be formed from a liquid crystal polymer material such as Dupont™ Zenite® 5000, 6000, 7000, or 9000HT series liquid crystal polymers. It should be understood that the sidewall ring 106 may be formed from a different material than the base substrate 102 or from the same material as the base substrate 102.

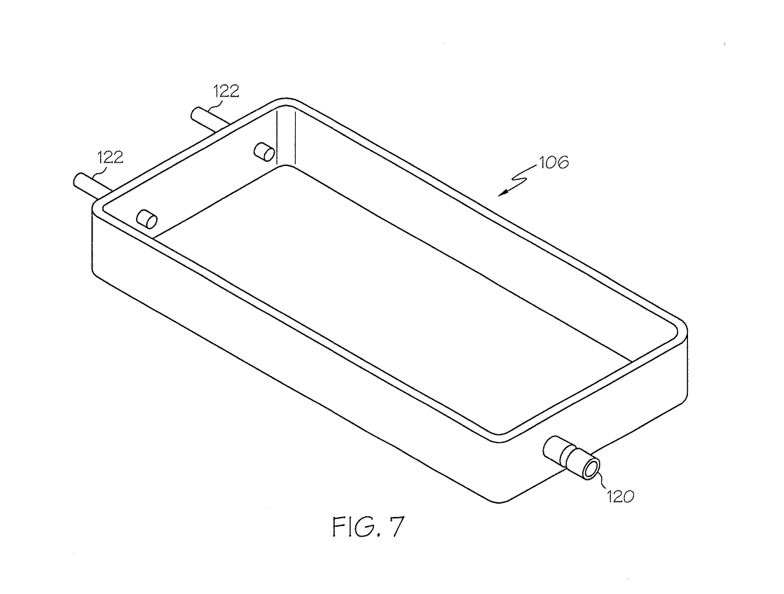

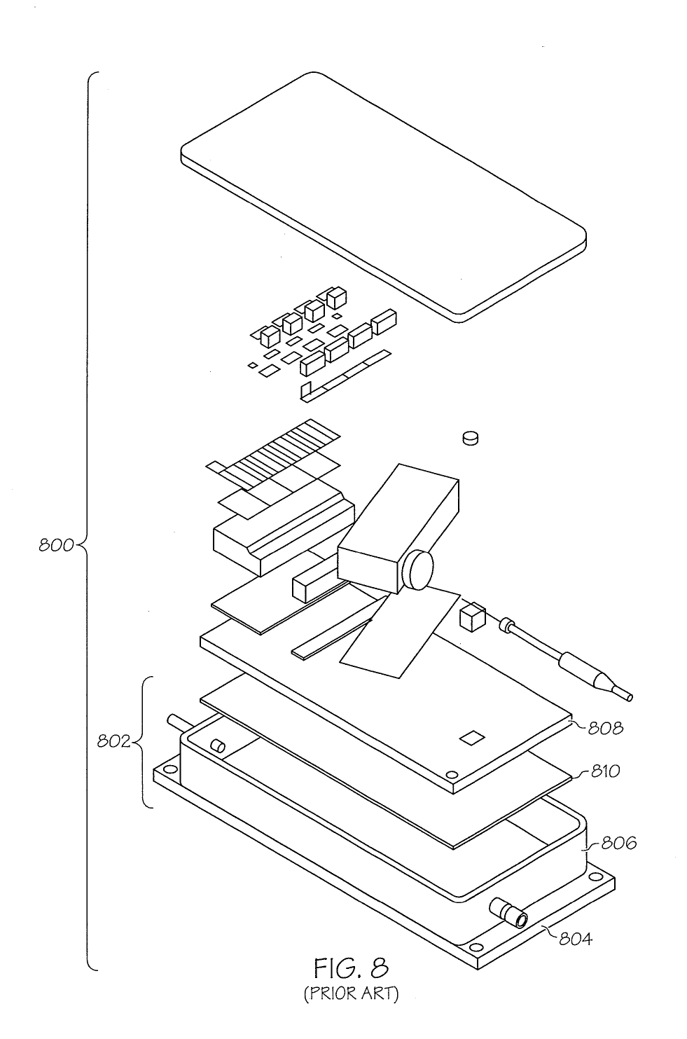

Still referring to FIGS. 1, 2 and 7, the sidewall ring 106 is generally formed with a plurality of fittings and connectors to facilitate electrically and optically coupling the multi-emitter laser pump package 100 to external devices. Specifically, the sidewall ring 106 may include at least one electrical connector 122 (two electrical connectors 122 are schematically depicted in FIGS. 2 and 7) which extends through the thickness of the sidewall ring 106. The electrical connectors 122 facilitate electrically coupling the chip-on-hybrid laser assembly 132 to an external power supply and control electronics. In the embodiments described herein, the at least one electrical connector 122 is formed from a conductive metallic material, such as copper alloys, aluminum alloys, platinum alloys, gold alloys, nickel alloys or the like. In one particular embodiment, the at least one electrical conductor 122 is formed from Alloy 42 which is a nickel-iron alloy that is generally compatible with materials used in electronic packaging.

In the embodiments of the multi-emitter laser pump package 100 described herein, the sidewall ring 106 also includes a fiber interconnect fitting 120 in which a fiber interconnect 130 is positioned and secured. The fiber interconnect fitting 120 generally extends through the thickness of the sidewall ring 106 and may be formed from a metallic material, such as copper alloys, aluminum alloys, platinum alloys, gold alloys, nickel alloys or the like. In one particular embodiment, the fiber interconnect fitting 120 is formed from Alloy 42. However, it should be understood that the fiber interconnect fitting 120 may be formed from other materials such as polymers, ceramics or even composite materials.

Referring again to FIGS. 1 and 2, the lid 104 of the multi-emitter laser pump package 100 is positioned on the sidewall ring 106 and encloses the optical components of the multi-emitter laser pump package 100 in the housing formed by the base substrate 102, the sidewall ring 106 and the lid 104. In the embodiments described herein, the lid 104 is generally formed from a material suitable for electronics packaging including, without limitation, ceramics such as alumina, silicon carbide and the like, metal such as copper alloys, aluminum alloys, and the like, or polymers, such as liquid crystal polymer. For example, in one embodiment, the lid 104 may be formed from a liquid crystal polymer material such as Dupont™ Zenite® 5000, 6000, 7000, or 9000HT series liquid crystal polymers, as described above with respect to the sidewall ring 106. However, it should be understood that the lid 104 may be formed from the same material as the sidewall ring 106 and/or base substrate 102 or from a different material than the sidewall ring 106 and the base substrate 102.

Still referring to FIGS. 1 and 2, a plurality of optical components are positioned in the housing formed by the base substrate 102, the sidewall ring 106 and the lid 104 to generate a coherent optical output from the multi-emitter laser pump package 100. The optical output of the package 100 is initially produced by a chip-on-hybrid laser assembly 132. The chip-on-hybrid laser assembly 132 is a semiconductor device which includes a plurality of laser diodes, such as laser diode chips, which are mounted on a substrate, such as an alumina substrate. The chip-on-hybrid laser assembly 132 may include a single substrate onto which a plurality of laser diode chips are mounted or, alternatively, may include a plurality of individual substrates, each of which includes one or more laser diode chips mounted thereon. In the embodiments of the multi-emitter laser pump package 100 described herein, the chip-on-hybrid laser assembly 132 includes four laser diodes, each of which independently emits a laser beam. For example, the chip-on-hybrid laser assembly 132 may include laser diode chips such as Model No. CL-915-010W-150 laser diode chip manufactured by Axcel photonics. Alternatively, the chip-on-hybrid laser assembly 132 may include Model No. 63-00352 laser diode chips manufactured by JDS Uniphase Corporation or Model No. SES11-975-02 laser diode chips manufactured by Oclaro, Inc. However, it should be understood that other, similar laser diode chips may be used in the chip-on-hybrid laser assembly. Further, the chip-on-hybrid laser assembly may include fewer than four laser diodes or more than four laser diodes. In the embodiments described herein, the chip-on-hybrid laser assembly 132 is positioned on the laser riser block 124 and bonded to the laser riser block 124 with a solder preform 134. The chip-on-hybrid laser assembly 132 is electrically coupled to the at least one electrical connector 122 positioned in the sidewall ring 106. For example, in one embodiment, the chip-on-hybrid laser assembly 132 is coupled to the at least one electrical connector 122 with a jumper wire 148.

The optical output of the chip-on-hybrid laser assembly 132 is directed into a scalar module 108 which re-orients the optical output of the chip-on-hybrid laser assembly 132 from a horizontal array (i.e., an array in the x-y plane of the coordinate axes depicted in FIG. 1) to a vertically stacked array (i.e., an array in the x-z plane of the coordinate axes depicted in FIG. 1) as described in U.S. patent Ser. No. 13/118,939 entitled “Method and Apparatus for Combining Light Sources in a Pump Laser Array” [Attorney Docket No. SP11-117] filed May 31, 2011 and assigned to Corning, Inc., the entirety of which is incorporated herein by reference. The scalar module 108 may be referred to as an “Etendue Aspect Ratio Scalar.” The scalar module 108 is positioned on the base substrate 102 between the optics riser block 126 and the fiber interconnect riser block 128 such that the optical output of the chip-on-hybrid laser assembly 132 is directed through the scalar module 108 before entering the fiber interconnect 130. In the embodiments described herein, the scalar module 108 is adhesively bonded to the base substrate 102 with an adhesive 110. For example, in one embodiment, the adhesive 110 is OPTOCAST 3415 optical adhesive manufactured by Electronic Materials Inc. However, it should be understood that other suitable adhesive materials may also be used to bond the scalar module 108 to the base substrate 102.

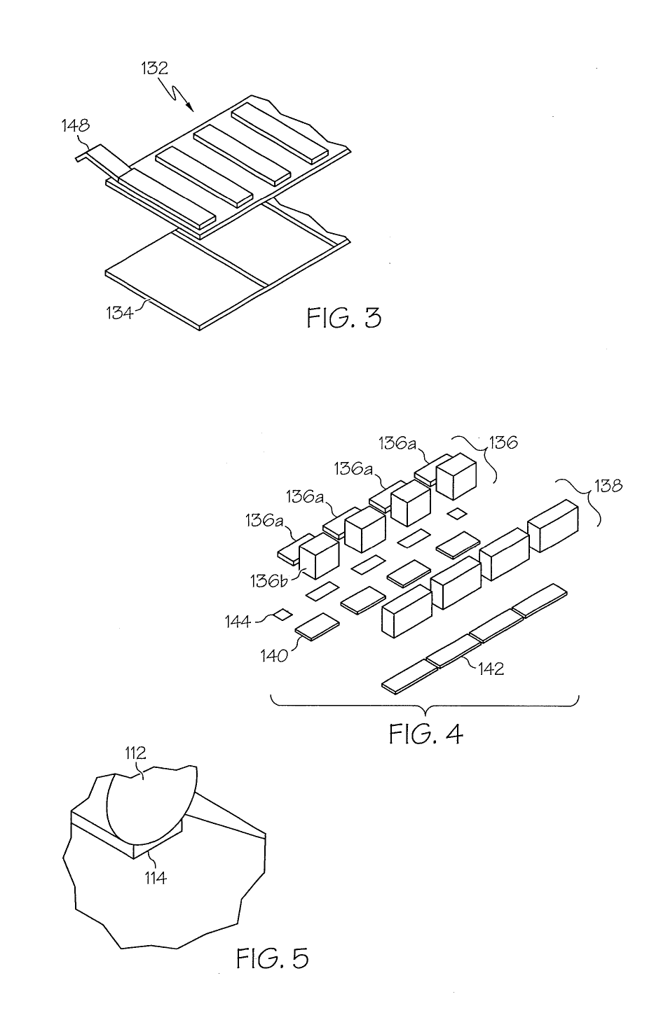

Referring now to FIGS. 1, 2 and 4, the output of the chip-on-hybrid laser assembly 132 is optically coupled into the scalar module 108 with collimating optics. In the embodiments described herein, the collimating optics include a set of fast-axis collimating optics 136 and a set of slow-axis collimating optics 138. In one particular embodiment, the fast-axis collimating optics 136 may include primary fast-axis collimating optics 136a and secondary fast-axis collimating optics 136b, as depicted in FIG. 4. However, it should be understood that, in other embodiments, the multi-emitter laser pump package 100 may be constructed with fast-axis collimating optics 136 which only include the primary fast-axis collimating optics 136a. In the embodiments described herein, the primary fast-axis collimating optics 136 are Part No. D141-757 lenses manufactured by Doric Lenses, Inc. The secondary fast-axis collimating optics, when included, may comprise lenses manufactured in accordance with Corning, Inc. drawing number 156228 by Doric Lenses, Inc. The slow-axis collimating optics may comprise lenses manufactured in accordance with Corning, Inc. drawing number 156229 by Doric Lenses, Inc. However, it should be understood that other, similar lenses may be used for the primary fast-axis collimating optics, the secondary fast-axis collimating optics, and the slow-axis collimating optics.

In the embodiments of the multi-emitter laser pump package 100 described herein, the first set of fast-axis collimating optics 136 are positioned on the laser riser block 124 such that the optical output of the chip-on-hybrid laser assembly 132 passes through the fast-axis collimating optics 136 before passing through the slow-axis collimating optics 138. The fast-axis collimating optics 136 are secured to the laser riser block 124 with UV-curable adhesives 140, 144. In one embodiment, the UV-curable adhesives 140, 144 are OPTOCAST 3408 optical adhesive manufactured by Electronics Materials Inc. However, it should be understood that other UV-curable adhesives may also be utilized to secure the fast-axis collimating optics 136 to the laser riser block 124.

Still referring to FIGS. 1, 2 and 4, the slow-axis collimating optics 138 are positioned on the optics riser block 126 such that the optical output of the chip-on-hybrid laser assembly 132 passes through the fast-axis collimating optics 136 and the slow-axis collimating optics 138 before entering the scalar module 108. The slow-axis collimating optics 138 are secured to the optics riser block 126 with UV-curable adhesive 142. In one embodiment, the UV-curable adhesive 142 is OPTOCAST 3408 optical adhesive manufactured by Electronics Materials Inc., as described hereinabove. However, it should be understood that other UV-curable adhesives may also be utilized to secure the slow-axis collimating optics 138 to the optics riser block 126.

Referring now to FIGS. 1, 2 and 5, the optical output of the scalar module 108 is optically coupled into a focusing lens 112 which focuses the optical output of the scalar module 108 into the fiber interconnect 130. The focusing lens 112 is affixed to the base substrate 102 and secured in place with a UV-curable adhesive 114. In one embodiment, the UV-curable adhesive 114 is OPTOCAST 3408 optical adhesive manufactured by Electronics Materials Inc., as described hereinabove. However, it should be understood that other UV-curable adhesives may also be utilized to secure the focusing lens to the base substrate 102.

As shown in FIGS. 1 and 2, the fiber interconnect 130 is positioned in the fiber interconnect fitting 120 of the sidewall ring 106. The fiber interconnect 130 generally comprises an optical fiber pigtail around which one or more layers of heat shrink material, such as heat shrink tubing, are positioned. The heat shrink material facilitates positioning and securing the fiber interconnect 130 in the fiber interconnect fitting 120 without damaging the optical fiber pigtail. In the embodiments described herein, the fiber interconnect 130 is secured to the fiber interconnect riser block 128 with a UV-curable adhesive 146. For example, in one embodiment, the UV-curable adhesive used to secure the fiber interconnect 130 to the fiber interconnect riser block 128 is OP 4-20632 UV-curable adhesive manufactured by Dymax Corporation. However, it should be understood that other UV-curable adhesive materials may also be used to secure the fiber interconnect 130 to the fiber interconnect riser block 128.

Methods for assembling the multi-emitter laser pump package 100 will now be described with specific reference to FIGS. 1-7. In the embodiments described herein, the various optical components may be positioned and aligned in the multi-emitter laser pump package 100 utilizing commercially available micro-optic alignment and assembly equipment such as the micro-optic alignment and assembly equipment manufactured by FiconTEC Service GmbH of Germany.

Referring to FIGS. 1-3, the solder preform 134 is positioned on the laser riser block 124 of the base substrate 102 and the chip-on-hybrid laser assembly 132 is positioned on the solder preform 134. In one embodiment, the solder preform 134 comprises an SAC-305 SnAgCu eutectic solder preform. The solder preform 134 is then heated to about 40° C. over the eutectic temperature of the preform and force cooled with nitrogen to about 20° C. below the eutectic temperature of the preform to bond the chip-on-hybrid laser assembly 132 to the laser riser block 124. An adhesive 110 is also deposited on the base substrate 102 between the optics riser block 126 and the fiber interconnect riser block 128. The scalar module 108 is positioned on the adhesive 110 to bond the scalar module 108 to the base substrate 102.

Referring to FIGS. 1-2 and 4, the collimating optics are positioned on the laser riser block 124 and the optics riser block 126 such that the output of the chip-on-hybrid laser assembly 132 is directed through the collimating optics and into an input of the scalar module 108 and an optical output of the scalar module 108 is maximized.

Specifically, adhesive 144 is dispensed on to the laser riser block 124 and/or the chip-on-hybrid laser assembly 132, as depicted in FIG. 1. The primary fast-axis collimating optics 136a are then positioned on the adhesive 144 and the positions of the primary fast-axis collimating optics 136a are adjusted on the laser riser block 124 to align the output of the chip-on-hybrid laser assembly 132 with the input of the scalar module 108 such that the optical output of the scalar module 108 is maximized. This alignment step is accomplished with active optical alignment in which the chip-on-hybrid laser assembly 132 is provided with power and switched on such that the output of the chip-on-hybrid laser assembly 132 is directed through the primary fast-axis collimating optics 136a and into the scalar module 108. Simultaneously, the optical output of the scalar module 108 is monitored with an optical detector. The positions of the primary fast-axis collimating optics 136a are then adjusted on the laser riser block 124 until the optical output of the scalar module 108 is peaked (i.e., maximized), as determined with the optical detector.

Once the output of the scalar module 108 is optimized, the adhesive 144 is cured with a UV light source to secure the primary fast-axis collimating optics 136a in place. In some embodiments, the base substrate 102 is placed in an oven and baked to further cure the adhesive 144.

Thereafter, adhesive 142 is dispensed onto the optics riser block 126. The slow-axis collimating optics 138 are then positioned on the adhesive 142 and the positions of the slow-axis collimating optics 138 are adjusted on the optics riser block 126 to align the output of the chip-on-hybrid laser assembly 132 with the input of the scalar module 108 such that the optical output of the scalar module 108 is maximized. This alignment step is accomplished with active optical alignment in which the chip-on-hybrid laser assembly 132 is provided with power and switched on such that the output of the chip-on-hybrid laser assembly 132 is directed through the slow-axis collimating optics 138 and into the scalar module 108. Simultaneously, the optical output of the scalar module 108 is monitored with an optical detector. The positions of the slow-axis collimating optics 138 are then adjusted until the optical output of the scalar module 108 is peaked (i.e., maximized), as determined with the optical detector.

Once the output of the scalar module 108 is optimized, the adhesive 142 is cured with a UV light source to secure the slow-axis collimating optics 138 in place. In some embodiments, the base substrate 102 is placed in an oven and baked to further cure the adhesive 142.

Optionally, additional adhesive 140 may be dispensed onto the laser riser block 124, as depicted in FIG. 1, and the secondary fast-axis collimating optics 136b are then positioned on the adhesive 140 and the positions of the secondary fast-axis collimating optics 136b are adjusted on the laser riser block 124 to align the output of the chip-on-hybrid laser assembly 132 with the input of the scalar module 108 such that the optical output of the scalar module 108 is maximized. This alignment step is accomplished with active optical alignment in which the chip-on-hybrid laser assembly 132 is provided with power and switched on such that the output of the chip-on-hybrid laser assembly 132 is directed through the secondary fast-axis collimating optics 136b and into the scalar module 108. Simultaneously, the optical output of the scalar module 108 is monitored with an optical detector. The positions of the secondary fast-axis collimating optics 136b are then adjusted until the optical output of the scalar module 108 is peaked (i.e., maximized), as determined with the optical detector.

Once the output of the scalar module 108 is optimized, the adhesive 140 is cured with a UV light source to secure the secondary fast-axis collimating optics 136b in place. In some embodiments, the base substrate 102 is placed in an oven and baked to further cure the adhesive 140.

Referring to FIGS. 1, 2 and 5, thereafter, an adhesive 114 is deposited proximate the optical output of the scalar module 108. The focusing lens 112 is then positioned on the adhesive 114 and aligned with the optical output of the scalar module 108 such that the optical output of the scalar module 108 is directed through the focusing lens 112. In one embodiment, active alignment techniques, as described above, may be utilized to align the focusing lens 112 with the optical output of the scalar module 108. Thereafter, the adhesive 114 is cured with a UV light source to secure the focusing lens 112 in place. In some embodiments, the base substrate 102 is placed in an oven and baked to further cure the adhesive 114.

Referring to FIGS. 1 and 2, once the focusing lens 112 is in place, a bead of non-hermetic adhesive 116 is deposited either on the sidewall ring 106 or the base substrate 102 and the sidewall ring 106 is positioned on the base substrate 102 such that the adhesive 116 bonds the sidewall ring 106 to the base substrate 102. The adhesive may be Ablebond 2039H manufactured by Henkel AG & Co. or an equivalent structural adhesive. In some embodiments, the adhesive 116 may be UV curable adhesive. In these embodiments, the adhesive may be cured with a UV light source. Alternatively, the adhesive 116 may be thermally curable. In these embodiments, the adhesive may be cured by placing the base substrate 102 and attached components in an oven and baking the components for a time and at a temperature sufficient to cure the adhesive. Positioning the sidewall ring 106 on the base substrate 102 after aligning the various optical components of the multi-emitter laser pump package 100 improves the ease of assembly and alignment of the various optical components.

Referring to FIGS. 2 and 3, thereafter, the chip-on-hybrid laser assembly 132 is electrically coupled to the electrical conductors 122 positioned in the sidewall ring 106. In one embodiment, the chip-on-hybrid laser assembly 132 is electrically coupled to the electrical conductors 122 with a wire 148 (FIG. 3) or metal ribbon by soldering. The wire may be formed from platinum, silver, gold, copper and/or alloys thereof.

Referring to FIGS. 1-2, in a next step, the fiber interconnect 130 is positioned in the fiber interconnect fitting 120 and optically aligned with the focusing lens 112. Specifically, a second end of the fiber interconnect 130 is positioned in the fiber interconnect fitting 120 located in the sidewall ring 106. The fiber interconnect fitting 120 is non-hermetically sealed to the fiber interconnect 130 such as with heat shrink material and/or adhesive. The first end of the fiber interconnect 130 is then optically aligned with the focusing lens 112. This alignment step may be performed using active alignment techniques to insure that optical output of the fiber interconnect 130 (and the optical output of the multi-emitter laser pump package) is maximized. Once the first end of the fiber interconnect 130 is optically aligned with the focusing lens 112, the fiber interconnect 130 is adhesively bonded to the fiber interconnect riser block 128 with adhesive 146. The adhesive 146 is then cured with UV and/or visible light sources. Optionally, the base substrate 102 with attached components is then baked to further cure the adhesive 146.

After the optical interconnect is installed, the lid 104 of the multi-emitter laser pump package 100 is installed on the sidewall ring 106. Specifically, a bead of non-hermetic adhesive 118 is positioned on either the lid 104 or the sidewall ring 106 and the lid 104 is installed on the sidewall ring 106 such that the adhesive 118 is disposed between the lid 104 and the sidewall ring 106. The adhesive may be Ablebond 2039H manufactured by Henkel AG & Co. or an equivalent structural adhesive. In some embodiments, the adhesive 118 may be UV curable adhesive. In these embodiments, the adhesive may be cured with a UV light source. Alternatively, the adhesive 118 may be thermally curable. In these embodiments, the adhesive may be cured by placing the multi-emitter laser pump package in an oven and baking the components for a time and at a temperature sufficient to cure the adhesive 118.

Once the lid 104 is installed, the multi-emitter laser pump package 100 may be code marked, such as by laser etching or the like, with appropriate identifying indicia (e.g., a serial number, model number, manufacturer name or the like).

The multi-emitter laser pump packages assembled according to the methods described herein may be used in a variety of applications. In one exemplary application, a plurality of multi-emitter laser pump packages are positioned in a common enclosure and the optical outputs of each package are coupled together to create an optical fiber laser with sufficient power to facilitate cutting and welding of metallic materials.

It should now be understood that the multi-emitter laser pumps described herein are non-hermetically sealed and, as such, the costs for manufacturing and assembling the multi-emitter laser pump packages are greatly reduced. Specifically, eliminating the hermiticity of the package reduces the material costs of the package as well as the assembly costs. Moreover, eliminating the hermiticity of the package also eliminates the use of several high-temperature soldering steps which, in earlier hermetic designs, were a significant source of component misalignment and corresponding production losses due to such misalignment. Accordingly, the present multi-emitter laser pump packages and methods for assembling the same not only reduce the overall cost of the package, but also improve manufacturing throughput by eliminating a costly source of misalignment from the assembly process.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method for assembling a multi-emitter laser pump package, the method comprising:
providing a base substrate comprising a laser riser block;
bonding a chip-on-hybrid laser assembly to the laser riser block with a solder preform;
bonding a scalar module to the base substrate with an adhesive such that an output of the chip-on-hybrid laser assembly is optically coupled into an input of the scalar module;
adhesively bonding a sidewall ring to the base substrate with a non-hermetic adhesive, the sidewall ring comprising a fiber interconnect fitting and at least one electrical connector; and
optically coupling a first end of a fiber interconnect to an output of the scalar module and positioning a second end of the fiber interconnect in the fiber interconnect fitting of the sidewall ring.

2. The method of claim 1, further comprising adhesively bonding a lid to the sidewall ring with a non-hermetic adhesive.

3. The method of claim 1, wherein the fiber interconnect is non-hermetically sealed to the fiber interconnect fitting.

4. The method of claim 1, wherein:
the base substrate comprises a fiber interconnect riser block; and
the method further comprises adhesively bonding the fiber interconnect to the fiber interconnect riser block.

5. The method of claim 1, further comprising:
positioning collimating optics on the base substrate such that the output of the chip-on-hybrid laser assembly is directed through the collimating optics and into an input of the scalar module and an optical output of the scalar module is maximized; and
bonding the collimating optics to the base substrate with adhesive.

6. The method of claim 5, wherein the base substrate further comprises an optics riser block positioned between the laser riser block and a front end of the base substrate; and
the collimating optics comprise a set of fast-axis collimating optics positioned on the laser riser block and adhesively bonded to the laser riser bock with adhesive and a set of slow-axis collimating optics positioned on the optics riser block and adhesively bonded to the optics riser block with adhesive.

7. The method of claim 5, wherein bonding the collimating optics to the base substrate comprises:
curing the adhesive with ultraviolet light; and
baking the base substrate and the collimating optics in an oven.

8. The method of claim 1, wherein the base substrate is formed from oxygen-free high conductivity copper.

9. The method of claim 1, wherein the base substrate is metal-injection-molded.

10. A method for assembling a multi-emitter laser pump package, the method comprising:
providing a base substrate formed from oxygen-free high conductivity copper and comprising a laser riser block, a fiber interconnect riser block, and an optics riser block positioned between the laser riser block and the fiber interconnect riser block, wherein the laser riser block is proximate a rear end of the base substrate and the fiber interconnect riser block is proximate a front end of the base substrate;
bonding a chip-on-hybrid laser assembly to the laser riser block with a solder preform;
bonding a scalar module to the base substrate with an adhesive;
positioning collimating optics on the laser riser block and the optics riser block such that an output of the chip-on-hybrid laser assembly is directed through the collimating optics and into an input of the scalar module and an optical output of the scalar module is maximized;
bonding the collimating optics to the laser riser block and the optics riser block with adhesive;
bonding a focusing lens to the base substrate with an adhesive;
adhesively bonding a sidewall ring to the base substrate, the sidewall ring comprising a fiber interconnect fitting and at least one electrical connector;
wire bonding the at least one electrical connector of the sidewall ring to the chip-on-hybrid laser assembly;
optically aligning an optical fiber interconnect with the focusing lens and the fiber interconnect fitting; and
bonding the optical fiber interconnect to the fiber interconnect riser block with adhesive.

11. The method of claim 10, further adhesively bonding a lid to the sidewall ring with a non-hermetic adhesive.

12. The method of claim 10, wherein the optical fiber interconnect is non-hermetically sealed to the fiber interconnect fitting.

13. The method of claim 10, wherein the collimating optics comprise a set of fast-axis collimating optics positioned on the laser riser block and a set of slow-axis collimating optics positioned on the optics riser block.

14. The method of claim 10, wherein bonding the collimating optics to the base substrate comprises:
curing the adhesive with ultraviolet light; and
baking the base substrate and the collimating optics in an oven.

15. A multi-emitter laser pump package comprising:
a base substrate comprising a laser riser block;
a sidewall ring adhesively bonded to the base substrate with a non-hermetic adhesive, the sidewall ring comprising a fiber interconnect fitting and at least one electrical connector;
a chip-on-hybrid laser assembly bonded to the laser riser block with a solder preform and electrically coupled to the at least one electrical connector of the sidewall ring;
a scalar module bonded to the base substrate with an adhesive and optically coupled to the chip-on-hybrid laser assembly such that an output of the chip-on-hybrid laser assembly is received by the scalar module, scaled and emitted from an output of the scalar module; and
a fiber interconnect having a first end optically coupled to the output of the scalar module and a second end positioned in the fiber interconnect fitting.

16. The package of claim 15, further comprising a lid bonded to the sidewall ring with a non-hermetic adhesive.

17. The package of claim 15, wherein the base substrate is formed from oxygen-free high conductivity copper.

18. The package of claim 15, wherein the fiber interconnect is non-hermetically bonded to the fiber interconnect fitting.

19. The package of claim 15, wherein the scalar module is optically coupled to the chip-on-hybrid laser assembly with collimating optics.

20. The package of claim 19, wherein:
the collimating optics comprise a fast-axis collimating optics and slow-axis collimating optics;
the base substrate comprises an optics riser block positioned between the laser riser block and the scalar module; and
the fast-axis collimating optics are adhesively bonded to the laser riser block and the slow-axis collimating optics are bonded to the optics riser block.
